(19) United States
(12) Patent Application Publication
(10) Pub. No.: US 2017/0209759 A1
(43) Pub. Date: Jul. 27, 2017

(54) TRAINING DEVICE

(71) Applicant: LeCharles Bentley, Gilbert, AZ (US)

(72) Inventor: LeCharles Bentley, Gilbert, AZ (US)

(21) Appl. No.: 15/413,212

(22) Filed: Jan. 23, 2017

Related U.S. Application Data
(60) Provisional application No. 62/281,920, filed on Jan. 22, 2016.

(51) Int. Cl. A63B 69/00; G09B 19/00

(52) U.S. Cl. CPC A63B 69/00; G09B 19/0038; A63B 2209/00

(57) ABSTRACT

An exercise training device includes a first bag portion having a semi-spherical front surface and a rear surface. A second bag portion has a semi-spherical second front surface and a second rear surface. The exercise training device includes an attachment structure having at least one arm extending between the first bag portion and the second bag portion. The at least one arm is attached to the rear surface and the second rear surface. A handle is attached to the at least one arm. The handle allows a user to hold the exercise training device.

### CROSS-REFERENCE TO RELATED APPLICATIONS

This application claims priority to U.S. Provisional Patent Application No. 62/281,920, filed on Jan. 22, 2016, the entire disclosure of which is hereby incorporated by reference.

### TECHNICAL FIELD

The instant application is generally directed towards an exercise training device. For example, the instant application is directed towards an exercise training device for assisting an athlete with proper hand positioning.

### BACKGROUND

Exercise training devices can be used to help athletes. Exercise training devices can be used, for example, to help athletes train in a variety of different sports.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, an exercise training device comprises a first bag portion having a semi-spherical front surface and a rear surface. A second bag portion has a semi-spherical second front surface and a second rear surface. An attachment structure comprises at least one arm extending between the first bag portion and the second bag portion. The at least one arm is attached to the rear surface and the second rear surface. A handle is attached to the at least one arm. The handle is configured to allow a user to hold the exercise training device

In an example, an exercise training device comprises a first bag portion having a semi-spherical front surface and a rear surface. A second bag portion has a semi-spherical second front surface and a second rear surface. An attachment structure comprises at least one arm extending between the first bag portion and the second bag portion. The at least one arm is attached to the rear surface and the second rear surface such that the rear surface is parallel to the second rear surface and the first bag portion is spaced a distance apart from the second bag portion.

In an example, an exercise training device comprises a first bag portion having a semi-spherical front surface and a rear surface. A second bag portion has a semi-spherical second front surface and a second rear surface. A third bag portion has a semi-spherical third front surface and a third rear surface. An attachment structure comprises at least one arm extending between the first bag portion and the second bag portion. The at least one arm is attached to the rear surface and the second rear surface. At least one second arm extends between the second bag portion and the third bag portion. The at least one second arm is attached to the second rear surface and the third rear surface. A handle is attached to one or more of the at least one arm and the at least one second arm. The handle is configured to allow a user to hold the exercise training device

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features can be arbitrarily increased or reduced for clarity of discussion.

FIG. 1 is an illustration of an example training device;

FIG. 2 is an illustration of an example training device;

FIG. 3 is an illustration of a portion of an example training device;

FIG. 4 is an illustration of an example training device;

FIG. 5 is an illustration of a portion of an example training device;

FIG. 6 is an illustration of an example training device; and

FIG. 7 is an illustration of an example training device.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the attachment of a first feature and a second feature in the description that follows can include embodiments in which the first feature and the second feature are attached in direct contact, and can also include embodiments in which additional features can be positioned between the first feature and the second feature, such that the first feature and the second feature are not in direct contact. In addition, the present disclosure can repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

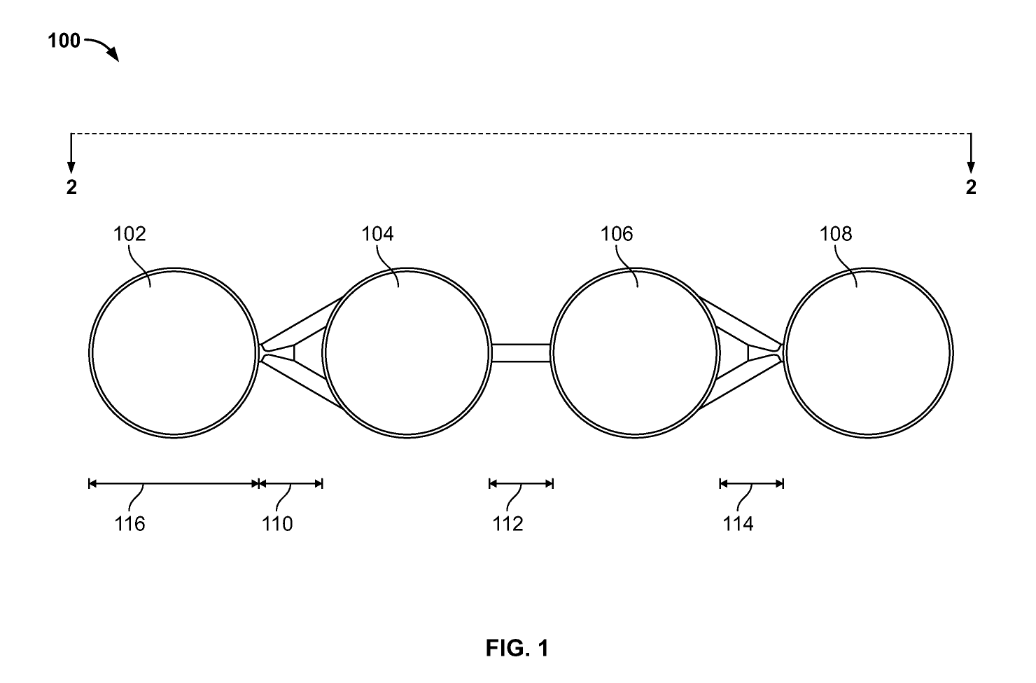

Referring to FIG. 1, an exercise training device 100 is provided for athletic training in a variety of sports. In an example, the exercise training device 100 could be used for football training, such as assisting an athlete with hand placement and/or proper striking of a target. In an example, the athlete can choose to strike a rounded, spherical portion of the exercise training device 100. The rounded, spherical portion of the exercise training device 100 is relatively soft and compressible, such as comprising foam, sponge, rubber, liquid, gas, etc.

The exercise training device 100 comprises one or more bag portions. In an example, the exercise training device 100 comprises a first bag portion 102, a second bag portion 104, a third bag portion 106, and a fourth bag portion 108. The first bag portion 102, the second bag portion 104, the third bag portion 106, and/or the fourth bag portion 108 may be substantially similar and/or identical to one another in structure, size, appearance, and/or function. In an example, the first bag portion 102 is spaced a distance 110 apart from the second bag portion 104. In an example, the second bag portion 104 is spaced a second distance 112 apart from the third bag portion 106. While the bag portions 102, 104, 106, 108 may comprise any number of shapes, in an example, one or more of the bag portions 102, 104, 106, 108 may comprise a circular cross-sectional shape. In an example, the third bag portion 106 is spaced a third distance 114 apart from the fourth bag portion 108. In an example, the distances 110, 112, 114 may be less than a cross-sectional size 116 (e.g., diameter) of the bag portions 102, 104, 106, 108.

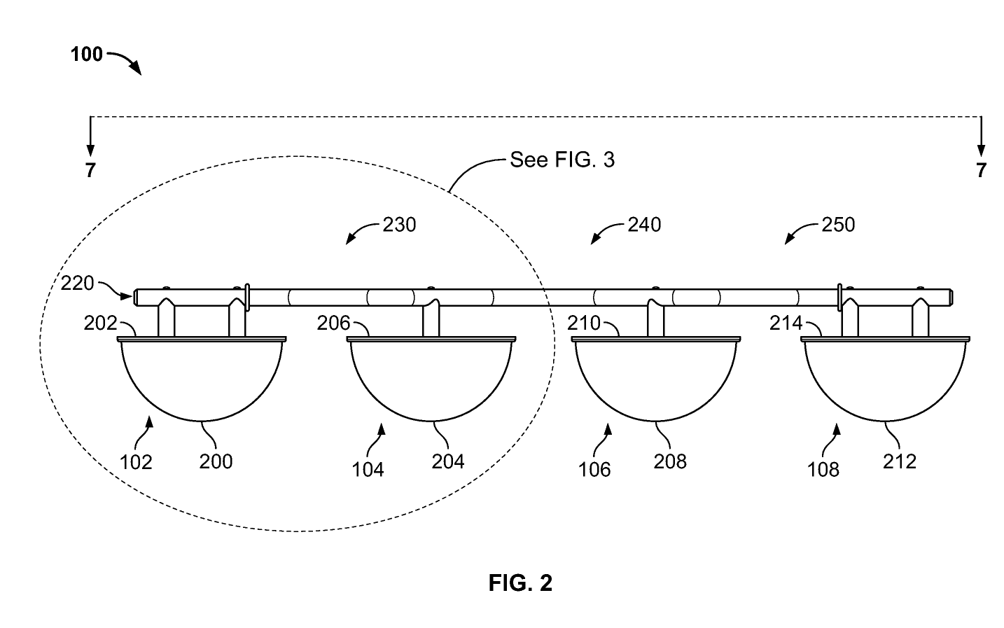

Referring to FIG. 2, a top down view of the exercise training device 100 as viewed from the perspective indicated by 2-2 in FIG. 1 is illustrated. In an example, the first bag portion 102 comprises a semi-spherical front surface 200 and a rear surface 202. The semi-spherical front surface 200 can be non-rigid and have at least some degree of compressibility or pliability. The first bag portion 102 can comprise a lightweight and/or compressible material, such as foam, feathers, rubber, sponge, liquid, gas, and/or the like. In an example, the first bag portion 102 can comprise a bag that is filled with the compressible material. The bag can comprise, for example, leather and/or a synthetic material (e.g., vinyl, PVC, canvas, etc.) that is resistant to abrasion, mildew, cutting, tearing, etc. The bag can be substantially hollow and can be selectively opened, such as with a zipper, for example. The bag can be filled with the compressible material. As such, when the bag is closed (e.g., zipper teeth interlocked), the front surface 200 of the first bag portion 102 is soft and/or non-rigid, and can at least partially compress in response to a force. As such, a user can hit or strike the front surface 200 of the first bag portion 102 with energy being absorbed, dissipated, etc. by the first bag portion 102. In an example, the rear surface 202 comprises a substantially rigid and planar structure that is opposite the front surface 200.

In an example, the second bag portion 104 comprises a semi-spherical second front surface 204 and a second rear surface 206. The semi-spherical second front surface 204 can be non-rigid and have at least some degree of compressibility or pliability. The second bag portion 104 can comprise a lightweight and/or compressible material, such as foam, feathers, rubber, sponge, liquid, gas, and/or the like. In an example, the second bag portion 104 can comprise a bag that is filled with the compressible material. The bag can comprise, for example, leather and/or a synthetic material (e.g., vinyl, PVC, canvas, etc.) that is resistant to abrasion, mildew, cutting, tearing, etc. The bag can be substantially hollow and can be selectively opened, such as with a zipper, for example. The bag can be filled with the compressible material. As such, when the bag is closed (e.g., zipper teeth interlocked), the second front surface 204 of the second bag portion 104 is soft and/or non-rigid, and can at least partially compress in response to a force. As such, a user can hit or strike the second front surface 204 of the second bag portion 104 with energy being absorbed, dissipated, etc. by the second bag portion 104. In an example, the second rear surface 206 comprises a substantially rigid and planar structure that is opposite the second front surface 204.

In an example, the third bag portion 106 comprises a semi-spherical third front surface 208 and a third rear surface 210. The semi-spherical third front surface 208 can be non-rigid and have at least some degree of compressibility or pliability. The third bag portion 106 can comprise a lightweight and/or compressible material, such as foam, feathers, rubber, sponge, liquid, gas, and/or the like. In an example, the third bag portion 106 can comprise a bag that is filled with the compressible material. The bag can comprise, for example, leather and/or a synthetic material (e.g., vinyl, PVC, canvas, etc.) that is resistant to abrasion, mildew, cutting, tearing, etc. The bag can be substantially hollow and can be selectively opened, such as with a zipper, for example. The bag can be filled with the compressible material. As such, when the bag is closed (e.g., zipper teeth interlocked), the third front surface 208 of the third bag portion 106 is soft and/or non-rigid, and can at least partially compress in response to a force. As such, a user can hit or strike the third front surface 208 of the third bag portion 106 with energy being absorbed, dissipated, etc. by the third bag portion 106. In an example, the third rear surface 210 comprises a substantially rigid and planar structure that is opposite the third front surface 208.

In an example, the fourth bag portion 108 comprises a semi-spherical fourth front surface 212 and a fourth rear surface 214. The semi-spherical fourth front surface 212 can be non-rigid and have at least some degree of compressibility or pliability. The fourth bag portion 108 can comprise a lightweight and/or compressible material, such as foam, feathers, rubber, sponge, liquid, gas, and/or the like. In an example, the fourth bag portion 108 can comprise a bag that is filled with the compressible material. The bag can comprise, for example, leather and/or a synthetic material (e.g., vinyl, PVC, canvas, etc.) that is resistant to abrasion, mildew, cutting, tearing, etc. The bag can be substantially hollow and can be selectively opened, such as with a zipper, for example. The bag can be filled with the compressible material. As such, when the bag is closed (e.g., zipper teeth interlocked), the fourth front surface 212 of the fourth bag portion 108 is soft and/or non-rigid, and can at least partially compress in response to a force. As such, a user can hit or strike the fourth front surface 212 of the fourth bag portion 108 with energy being absorbed, dissipated, etc. by the fourth bag portion 108. In an example, the fourth rear surface 214 comprises a substantially rigid and planar structure that is opposite the fourth front surface 212.

The exercise training device 100 comprises an attachment structure 220 that can attach the first bag portion 102, the second bag portion 104, the third bag portion 106, and the fourth bag portion 108 together. In an example, the attachment structure 220 can be positioned adjacent to the rear surfaces 202, 206, 210, 214 of the bag portions 102, 104, 106, 108. The attachment structure 220 can maintain relative positions of the bag portions 102, 104, 106, 108 such that the bag portions 102, 104, 106, 108 are substantially fixed and the distances 110, 112, 114 separating adjacent bag portions 102, 104, 106, 108 remain the same.

In an example, the attachment structure 220 comprises at least one arm 230 extending between the first bag portion 102 and the second bag portion 104. The at least one arm 230 can be attached to the rear surface 202 of the first bag portion 102 and the second rear surface 206 of the second bag portion 104. In this way, the at least one arm 230 can function to attach the first bag portion 102 and the second bag portion 104. It will be appreciated that by extending between the first bag portion 102 and the second bag portion 104, the at least one arm 230 is not limited to being located in a space that is directly between the first bag portion 102 and the second bag portion 104 (e.g., located along a straight path between the first bag portion 102 and the second bag portion 104). Rather, by extending between the first bag portion 102 and the second bag portion 104, the at least one arm 230 can attach the first bag portion 102 and the second bag portion 104 while not being located in a straight path that is directly between the first bag portion 102 and the second bag portion 104. Indeed, the at least one arm 230 can attach the first bag portion 102 and the second bag portion 104 while extending along a rear side of the first bag portion 102 and the second bag portion 104.

In an example, the at least one arm 230 can attach the first bag portion 102 and the second bag portion 104 such that the rear surface 202 of the first bag portion 102 is parallel to the second rear surface 206 of the second bag portion 104. In an example, the at least one arm 230 can attach the first bag portion 102 and the second bag portion 104 such that the rear surface 202 of the first bag portion 102 is co-planar with the second rear surface 206 of the second bag portion 104.

In an example, the attachment structure 220 comprises at least one second arm 240 extending between the second bag portion 104 and the third bag portion 106. The at least one second arm 240 can be attached to the second rear surface 206 of the second bag portion 104 and the third rear surface 210 of the third bag portion 106. In this way, the at least one second arm 240 can function to attach the second bag portion 104 and the third bag portion 106. It will be appreciated that by extending between the second bag portion 104 and the third bag portion 106, the at least one second arm 240 is not limited to being located in a space that is directly between the second bag portion 104 and the third bag portion 106 (e.g., located along a straight path between the second bag portion 104 and the third bag portion 106). Rather, by extending between the second bag portion 104 and the third bag portion 106, the at least one second arm 240 can attach the second bag portion 104 and the third bag portion 106 while not being located in a straight path that is directly between the second bag portion 104 and the third bag portion 106. Indeed, the at least one second arm 240 can attach the second bag portion 104 and the third bag portion 106 while extending along a rear side of the second bag portion 104 and the third bag portion 106.

In an example, the at least one second arm 240 can attach the second bag portion 104 and the third bag portion 106 such that the second rear surface 206 of the second bag portion 104 is parallel to the third rear surface 210 of the third bag portion 106. In an example, the at least one second arm 240 can attach the second bag portion 104 and the third bag portion 106 such that the second rear surface 206 of the second bag portion 104 is co-planar with the third rear surface 210 of the third bag portion 106.

In an example, the attachment structure 220 comprises at least one third arm 250 extending between the third bag portion 106 and the fourth bag portion 108. The at least one third arm 250 can be attached to the third rear surface 210 of the third bag portion 106 and the fourth rear surface 214 of the fourth bag portion 108. In this way, the at least one third arm 250 can function to attach the third bag portion 106 and the fourth bag portion 108. It will be appreciated that by extending between the third bag portion 106 and the fourth bag portion 108, the at least one third arm 250 is not limited to being located in a space that is directly between the third bag portion 106 and the fourth bag portion 108 (e.g., located along a straight path between the third bag portion 106 and the fourth bag portion 108). Rather, by extending between the third bag portion 106 and the fourth bag portion 108, the at least one third arm 250 can attach the third bag portion 106 and the fourth bag portion 108 while not being located in a straight path that is directly between the third bag portion 106 and the fourth bag portion 108. Indeed, the at least one third arm 250 can attach the third bag portion 106 and the fourth bag portion 108 while extending along a rear side of the third bag portion 106 and the fourth bag portion 108.

In an example, the at least one third arm 250 can attach the third bag portion 106 and the fourth bag portion 108 such that the third rear surface 210 of the third bag portion 106 is parallel to the fourth rear surface 214 of the fourth bag portion 108. In an example, the at least one third arm 250 can attach the third bag portion 106 and the fourth bag portion 108 such that the third rear surface 210 of the third bag portion 106 is co-planar with the fourth rear surface 214 of the fourth bag portion 108.

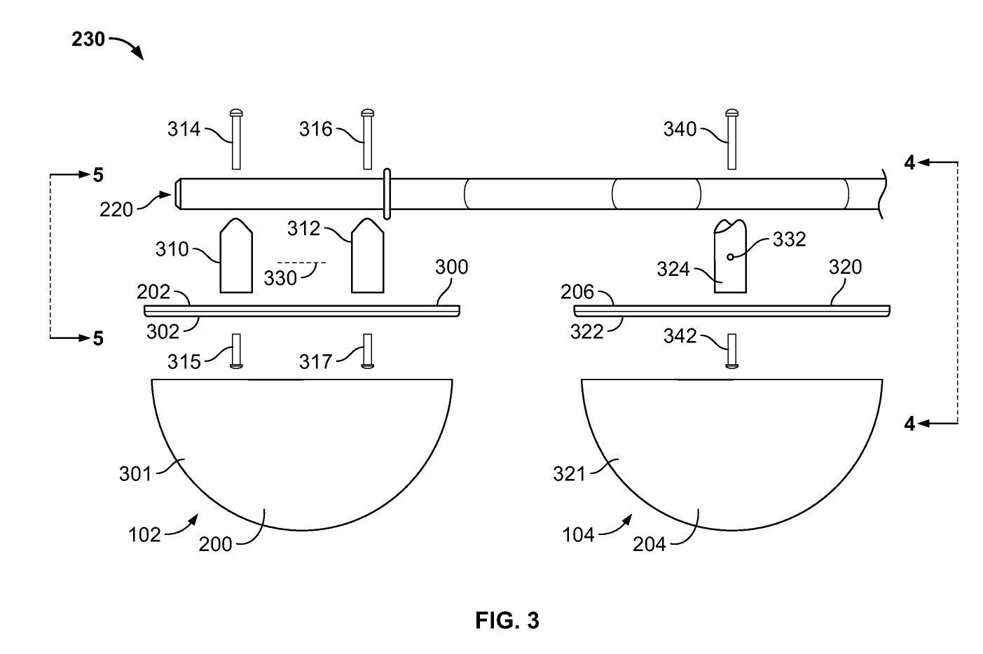

Referring to FIG. 3, a partially exploded illustration of the first bag portion 102 and the second bag portion 104 is illustrated. In an example, the first bag portion 102 comprises a backing portion 300. The backing portion 300 can be substantially planar and can comprise a rigid structure such as a metal material, a plastic material, a composite, etc. The backing portion 300 is illustrated as being separated from a compressible portion 301 of the first bag portion 102. However, in operation and during use, the backing portion 300 can be adhered to the compressible portion 301, such as with mechanical fasteners, adhesives, one piece formed, etc. The backing portion 300 comprises a first surface, which faces the compressible portion 301, and the rear surface 202.

The backing portion 300 of the first bag portion 102 can be attached to the attachment structure 220 by one or more connecting structures. For example, a connecting structure 310 and a second connecting structure 312 can attach the backing portion 300 to the attachment structure 220. In an example, the connecting structure 310 and the second connecting structure 312 can extend substantially parallel to each other along separate axes. In an example, the connecting structure 310 and the second connecting structure 312 can extend substantially perpendicular to the backing portion 300 and to the attachment structure 220.

In an example, a first fastener 314 can attach the connecting structure 310 to the attachment structure 220, while a second fastener 315 can attach the connecting structure 310 to the backing portion 300. The first fastener 314 and the second fastener 315 can comprise any number of types of mechanical fasteners, such as bolts, screws, etc. In an example, the first fastener 314 can pass through the attachment structure 220 and can be received within a first end of the connecting structure 310. Likewise, in an example, the second fastener 315 can pass through the backing portion 300 and can be received within a second end of the connecting structure 310.

The second connecting structure 312 can be spaced a distance apart from the connecting structure 310. In an example, a third fastener 316 can attach the second connecting structure 312 to the attachment structure 220, while a fourth fastener 317 can attach the second connecting structure 312 to the backing portion 300. The third fastener 316 and the fourth fastener 317 can comprise any number of types of mechanical fasteners, such as bolts, screws, etc. In an example, the third fastener 316 can pass through the attachment structure 220 and can be received within a first end of the second connecting structure 312. Likewise, in an example, the fourth fastener 317 can pass through the backing portion 300 and can be received within a second end of the second connecting structure 312.

In an example, the second bag portion 104 comprises a second backing portion 320. The second backing portion 320 can be substantially planar and can comprise a rigid structure such as a metal material, a plastic material, a composite, etc. The second backing portion 320 is illustrated as being separated from a second compressible portion 321 of the second bag portion 104. However, in operation and during use, the second backing portion 320 can be adhered to the second compressible portion 321, such as with mechanical fasteners, adhesives, one piece formed, etc. The second backing portion 320 comprises a first surface, which faces the second compressible portion 321, and the second rear surface 206. In an example, the second backing portion 320 can extend substantially parallel to and/or co-planar with the backing portion 300.

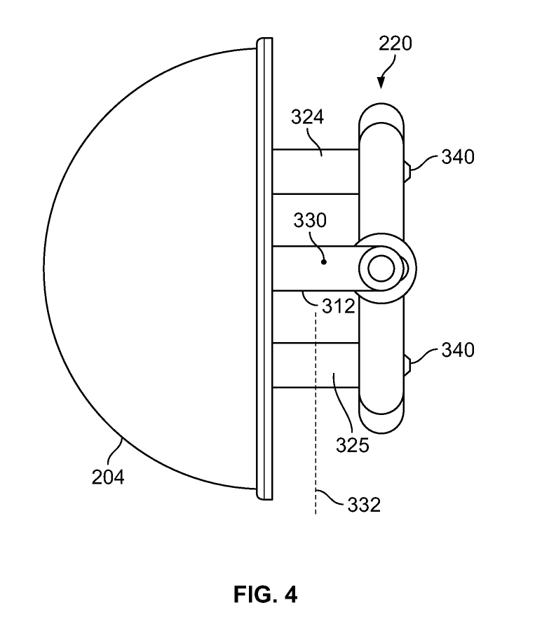

The second backing portion 320 of the second bag portion 104 can be attached to the attachment structure 220 by one or more connecting structures. For example, a third connecting structure 324 and a fourth connecting structure 325 (obstructed from view in FIG. 3, but illustrated in FIG. 4) can attach the second backing portion 320 to the attachment structure 220. In an example, the third connecting structure 324 and the fourth connecting structure 325 can extend substantially parallel to each other along separate axes. In an example, the third connecting structure 324 and the fourth connecting structure 325 can extend substantially perpendicular to the second backing portion 320 and to the attachment structure 220.

In an example, the third connecting structure 324 and the fourth connecting structure 325 can be oriented along an axis that is substantially perpendicular to an axis along which the connecting structure 310 and the second connecting structure 312 are oriented. For example, an axis 330 can intersect the connecting structure 310 and the second connecting structure 312, with the axis 330 extending left-right in FIG. 3. The axis 330 can extend into and out of the page in FIG. 4. A second axis 332 can intersect the third connecting structure 324 and the fourth connecting structure 325, with the second axis 332 extending into and out of the page in FIG. 3. The second axis 332 can extend vertically up-down in FIG. 4. As such, in an example, the axis 330 may be substantially perpendicular to the second axis 332. Such an orientation of the connecting structures 310, 312, 324, 325 can assist in improving stabilization of the exercise training device 100 during use, while also more widely distributing forces that are applied to the exercise training device 100 during use.

In an example, a fifth fastener 340 can attach the third connecting structure 324 to the attachment structure 220, while a sixth fastener 342 can attach the third connecting structure 324 to the second backing portion 320. The fifth fastener 340 and the sixth fastener 342 can comprise any number of types of mechanical fasteners, such as bolts, screws, etc. In an example, the fifth fastener 340 can pass through the attachment structure 220 and can be received within a first end of the third connecting structure 324. Likewise, in an example, the sixth fastener 342 can pass through the second backing portion 320 and can be received within a second end of the third connecting structure 324. The third connecting structure 324 can be spaced a distance apart from the fourth connecting structure 325. In an example, fasteners similar to the fifth fastener 340 and the sixth fastener 342 can attach the third connecting structure 324 to the attachment structure 220 and the second backing portion 320.

Referring to FIG. 4, a side view of the exercise training device as viewed from the perspective indicated by 4-4 in FIG. 3 is illustrated. In an example, when the connecting structures 310, 312, 324, 325 attach the bag portions 102, 104, 106, 108 to the attachment structure 220, the bag portions 102, 104, 106, 108 can be spaced a distance apart from the attachment structure 220. For example, a gap, a space, an opening, etc. can be defined between the attachment structure 220 and the bag portions 102, 104, 106, 108.

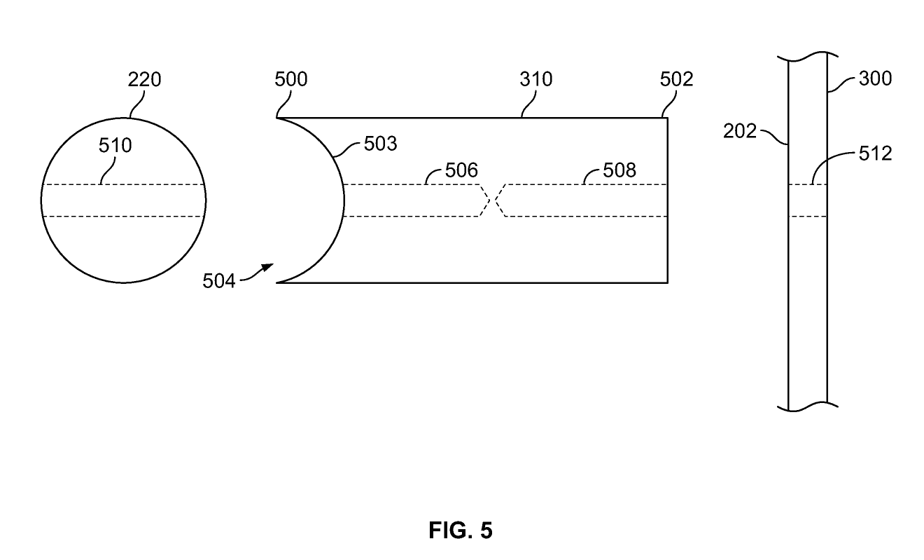

Referring to FIG. 5, an example of the connecting structure 310 is illustrated. It will be appreciated that the other, unillustrated connecting structures (e.g., 312, 324, 325, etc.) may be substantially similar and/or identical to the connecting structure 310 of FIG. 4. In an example, the connecting structure 310 can extend along an axis between a first end 500 and a second end 502. At the first end 500, the connecting structure 310 comprises a wall 503 that defines a channel 504. In an example, the channel 504 can have a shape that substantially matches a shape of the attachment structure 220. For example, the attachment structure 220 has a circular cross-sectional shape. As such, the channel 504 can likewise have a rounded, semi-circular shape. In this way, the connecting structure 310 can receive the attachment structure 220 within the channel 504.

The connecting structure 310 can define a first fastener opening 506 at the first end 500, and a second fastener opening 508 at the second end 502. In an example, the attachment structure 220 can define a third fastener opening 510 that can be aligned with the first fastener opening 506 when the attachment structure 220 is received within the channel 504. In an example, the backing portion 300 can define a fourth fastener opening 512 that can be aligned with the second fastener opening 508. In this way, the first fastener 314 (e.g., illustrated in FIG. 3) can be received within the first fastener opening 506 and the third fastener opening 510 to attach the connecting structure 310 and the attachment structure 220. Likewise, the second fastener 315 (e.g., illustrated in FIG. 3) can be received within the second fastener opening 508 and the fourth fastener opening 512 to attach the connecting structure 310 and the backing portion 300.

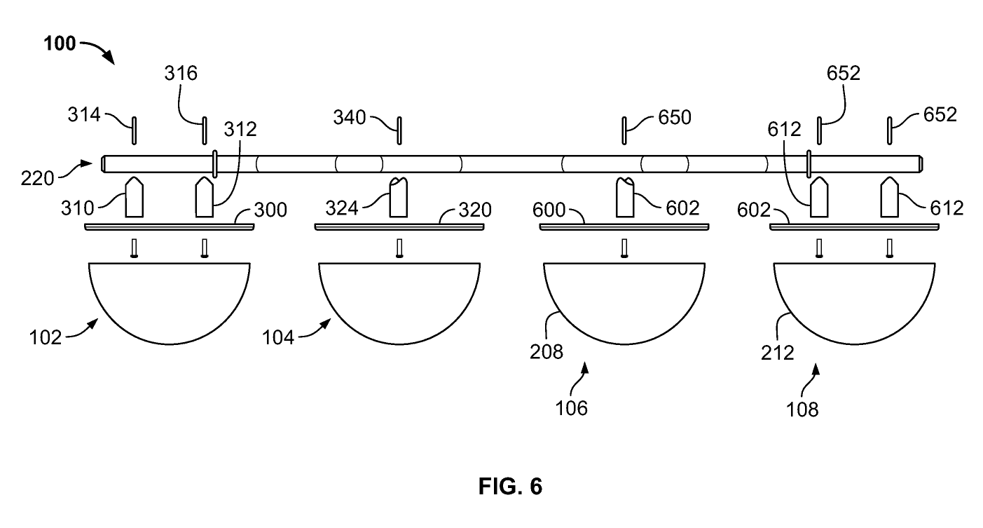

Referring to FIG. 6, an exploded view of the exercise training device 100 is illustrated. In an example, the third bag portion 106 comprises a third backing portion 600. The third backing portion 600 is substantially similar to the first backing portion 300 and the second backing portion 320. In an example, the third bag portion 106 can be attached to the attachment structure 220 in a similar manner as the second bag portion 104 is attached to the attachment structure 220. For example, the third bag portion 106 may comprise fifth connecting structures 602, which may be substantially similar to the third connecting structure 324 and the fourth connecting structure 325 illustrated in FIGS. 3 and 4. One or more fasteners 650, which may be substantially similar to the fifth fastener 340 and the sixth fastener 342, can attach the fifth connecting structures 602 to the attachment structure 220 and to the third backing portion 600.

In an example, the fourth bag portion 108 comprises a fourth backing portion 610. The fourth backing portion 610 is substantially similar to the first backing portion 300, the second backing portion 320, and the third backing portion 600. In an example, the fourth bag portion 108 can be attached to the attachment structure 220 in a similar manner as the first bag portion 102 is attached to the attachment structure 220. For example, the fourth bag portion 108 may comprise sixth connecting structures 612, which may be substantially similar to the connecting structure 310 and the second connecting structure 312 illustrated in FIG. 3. One or more fasteners 652, which may be substantially similar to the first fastener 314, the second fastener 315, the third fastener 316, and the fourth fastener 317, can attach the sixth connecting structures 612 to the attachment structure 220 and to the fourth backing portion 610.

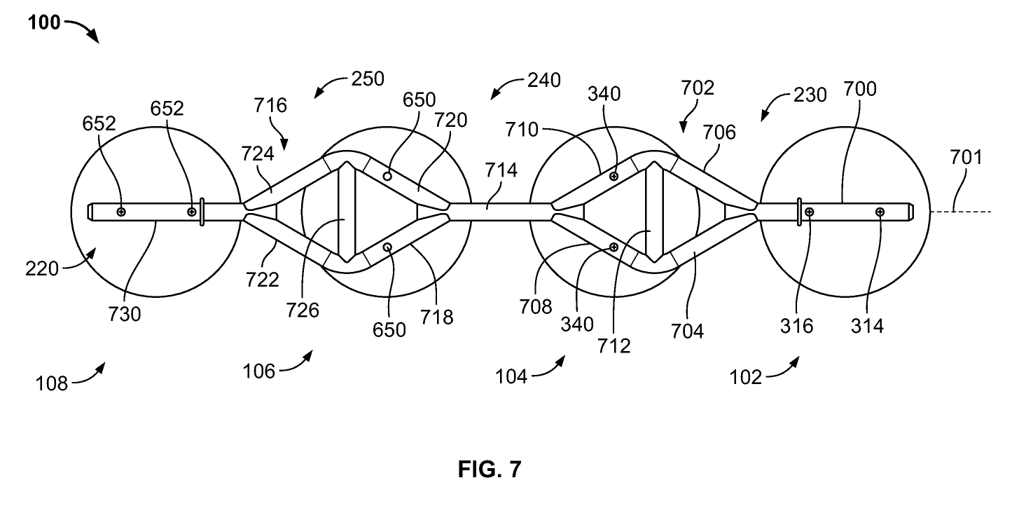

Referring to FIG. 7, a rear view of the exercise training device 100 as viewed from the perspective indicated by 7-7 in FIG. 2 is illustrated. In an example, the attachment structure 220 comprises the at least one arm 230, the at least one second arm 240, and the at least one third arm 250 for attaching the first bag portion 102, the second bag portion 104, the third bag portion 106 and the fourth bag portion 108. The arms 230, 240, 250 of the attachment structure 220 can comprise a rigid structure such as a metal material, a plastic material, a composite, etc.

The at least one arm 230 comprises a first arm 700. The first arm 700 can define one or more openings for receiving the first fastener 314 and the second fastener 315. In this way, the connecting structure 310 and the second connecting structure 312 (e.g., also illustrated in FIG. 3) can be attached to the first arm 700. As such, the first bag portion 102 can be attached to the first arm 700. In an example, the first arm 700 can extend along an arm axis 701. During operation, the arm axis 701 can extend substantially parallel to a surface upon which a user stands (e.g., the ground, the floor, a field, etc.).

The at least one arm 230 comprises a first support structure 702 that can be attached to the first arm 700. In an example, the first support structure 702 can comprise a second arm 704, a third arm 706, a fourth arm 708, a fifth arm 710, and a handle 712. The second arm 704 can be attached to an end of the first arm 700, with the second arm 704 defining an angle with respect to the arm axis 701 that is between about 20 degrees to about 60 degrees. The third arm 706 can be attached to the end of the first arm 700, with the third arm 706 defining an angle with respect to the arm axis 701 that is between about 20 degrees to about 60 degrees. In an example, the second arm 704 is positioned on a first side of the arm axis 701 while the third arm 706 is positioned on a second side of the arm axis 701. The first arm 700, the second arm 704, and the and/or third arm 706 can be attached in any number of ways, such as with welding, adhesives, fasteners, etc.

The fourth arm 708 can be attached to an end of the second arm 704, with the fourth arm 708 defining an angle with respect to the arm axis 701 that is between about 20 degrees to about 60 degrees. The fifth arm 710 can be attached to an end of the third arm 706, with the fifth arm 710 defining an angle with respect to the arm axis 701 that is between about 20 degrees to about 60 degrees. In an example, the fourth arm 708 is positioned on a first side of the arm axis 701 (e.g., the same side as the second arm 704) while the fifth arm 710 is positioned on a second side of the arm axis 701 (e.g., the same side as the third arm 706). In an example, the fourth arm 708 can define an angle with respect to the second arm 704 that is between about 30 degrees to about 150 degrees. In an example, the fifth arm 710 can define an angle with respect to the third arm 706 that is between about 30 degrees to about 150 degrees.

The fourth arm 708 and the fifth arm 710 can define one or more openings for receiving the fifth fasteners 340. In this way, the third connecting structure 324 and the fourth connecting structure 325 (e.g., also illustrated in FIGS. 3 and 4) can be attached to the fourth arm 708 and the fifth arm 710. As such, the second bag portion 104 can be attached to the fourth arm 708 and the fifth arm 710.

The handle 712 can be attached to at least one arm and is configured to allow a user to hold the exercise training device 100. In an example, the handle 712 can be attached to ends of the second arm 704, the third arm 706, the fourth arm 708, and the fifth arm 710. The second arm 704, the third arm 706, the fourth arm 708, the fifth arm 710 and/or the handle 712 can be attached in any number of ways, such as with welding, adhesives, fasteners, etc. In an example, the handle 712 can extend substantially perpendicular to the arm axis 701 and to the first arm 700. In an example, the second arm 704, the third arm 706, the fourth arm 708, and the fifth arm 710 can define a quadrilateral shape, such as a parallelogram. In such an example, the second arm 704 and the fifth arm 710 can extend substantially parallel to each other, while the third arm 706 and the fourth arm 708 can extend substantially parallel to each other. Internal angles defined by the second arm 704, the third arm 706, the fourth arm 708, the fifth arm 710 may be less than 90 degrees or greater than 90 degrees.

The at least one second arm 240 comprises a sixth arm 714. In an example, the sixth arm 714 can extend substantially parallel to the arm axis 701 and the first arm 700. The sixth arm 714 can be attached to ends of the fourth arm 708 and the fifth arm 710. The fourth arm 708, the fifth arm 710, and the sixth arm 714 can be attached in any number of ways, such as with welding, adhesives, fasteners, etc. In an example, the first support structure 702 can be positioned between the first arm 700 and the sixth arm 714.

The at least one arm 240 comprises a second support structure 716 that can be attached to the sixth arm 714. In an example, the second support structure 716 can comprise a seventh arm 718, an eighth arm 720, a ninth arm 722, a tenth arm 724, and a second handle 726. The seventh arm 718 can be attached to an end of the sixth arm 714, with the seventh arm 718 defining an angle with respect to the arm axis 701 that is between about 20 degrees to about 60 degrees. The eighth arm 720 can be attached to the end of the sixth arm 714, with the eighth arm 720 defining an angle with respect to the arm axis 701 that is between about 20 degrees to about 60 degrees. In an example, the seventh arm 718 is positioned on a first side of the arm axis 701 while the eighth arm 720 is positioned on a second side of the arm axis 701. The sixth arm 714, the seventh arm 718, and the and/or eighth arm 720 can be attached in any number of ways, such as with welding, adhesives, fasteners, etc.

The ninth arm 722 can be attached to an end of the seventh arm 718, with the ninth arm 722 defining an angle with respect to the arm axis 701 that is between about 20 degrees to about 60 degrees. The tenth arm 724 can be attached to an end of the eighth arm 720, with the tenth arm 724 defining an angle with respect to the arm axis 701 that is between about 20 degrees to about 60 degrees. In an example, the ninth arm 722 is positioned on a first side of the arm axis 701 (e.g., the same side as the second arm 704 and the seventh arm 718) while the tenth arm 724 is positioned on a second side of the arm axis 701 (e.g., the same side as the third arm 706 and the eighth arm 720). In an example, the ninth arm 722 can define an angle with respect to the seventh arm 718 that is between about 30 degrees to about 150 degrees. In an example, the tenth arm 724 can define an angle with respect to the eighth arm 720 that is between about 30 degrees to about 150 degrees.

The eighth arm 720 and the ninth arm 722 can define one or more openings for receiving the fasteners 650. In this way, the fifth connecting structures 602 (e.g., also illustrated in FIG. 6) can be attached to the seventh arm 718 and the eighth arm 720. As such, the third bag portion 106 can be attached to the seventh arm 718 and the eighth arm 720.

The second handle 726 can be attached to at least one arm and is configured to allow a user to hold the exercise training device 100. In an example, the second handle 726 can be attached to ends of the seventh arm 718, the eighth arm 720, the ninth arm 722, and the tenth arm 724. The seventh arm 718, the eighth arm 720, the ninth arm 722, the tenth arm 724 and/or the second handle 726 can be attached in any number of ways, such as with welding, adhesives, fasteners, etc. In an example, the second handle 726 can extend substantially perpendicular to the arm axis 701, to the first arm 700 and to the sixth arm 714, while extending substantially parallel to the handle 712. In an example, the seventh arm 718, the eighth arm 720, the ninth arm 722, and the tenth arm 724 can define a quadrilateral shape, such as a parallelogram. In such an example, the seventh arm 718 and the tenth arm 724 can extend substantially parallel to each other, while the eighth arm 720 and the ninth arm 722 can extend substantially parallel to each other. Internal angles defined by the seventh arm 718, the eighth arm 720, the ninth arm 722, and the tenth arm 724 may be less than 90 degrees or greater than 90 degrees.

The at least one third arm 250 comprises an eleventh arm 730. In an example, the eleventh arm 730 can extend substantially parallel to the arm axis 701, the first arm 700, and the sixth arm 714. The eleventh arm 730 can be attached to ends of the ninth arm 722 and the tenth arm 724. The ninth arm 722, the tenth arm 724, and the eleventh arm 730 can be attached in any number of ways, such as with welding, adhesives, fasteners, etc. In an example, the second support structure 716 can be positioned between the sixth arm 714 and the eleventh arm 730.

The eleventh arm 730 can define one or more openings for receiving the fasteners 652. In this way, the sixth connecting structures 612 (e.g., also illustrated in FIG. 6) can be attached to the eleventh arm 730. As such, the fourth bag portion 108 can be attached to the eleventh arm 730.

In operation, the user can grip the handle 712 and the second handle 726 of the exercise training device 100. By gripping the handles 712, 726, the user can hold the exercise training device 100. With the user holding the exercise training device 100, an athlete can strike or contact one or more of the bag portions 102, 104, 106, 108. In an example, the athlete can strike the semi-spherically shaped front surfaces 200, 204, 208, 212 of the bag portions 102, 104, 106, 108.

It will be appreciated that while the figures illustrate possible dimensions of the first support portion, the second support portion, the third support portion, etc., these dimensions are merely exemplary and not intended to be limiting. The example dimensions merely illustrate possible dimensions of the first support portion, the second support portion, the third support portion, etc. In these examples, the first support portion, the second support portion, the third support portion, etc. can have a range of dimensions.

The foregoing outlines features of several embodiments so that those of ordinary skill in the art can better understand various aspects of the present disclosure. Those of ordinary skill in the art should appreciate that they can readily use the present disclosure as a basis for designing or modifying other processes and structures for carrying out the same purposes and/or achieving the same advantages of various embodiments introduced herein. Those of ordinary skill in the art should also realize that such equivalent constructions do not depart from the spirit and scope of the present disclosure, and that they can make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure can have been disclosed with respect to only one of several implementations, such feature can be combined with one or more other features of the other implementations as can be desired and advantageous for any given or particular application.

What is claimed is:

1. An exercise training device comprising:
a first bag portion having a semi-spherical front surface and a rear surface;
a second bag portion having a semi-spherical second front surface and a second rear surface;
an attachment structure comprising:
at least one arm extending between the first bag portion and the second bag portion, the at least one arm attached to the rear surface and the second rear surface; and
a handle attached to the at least one arm, the handle configured to allow a user to hold the exercise training device.

2. The exercise training device of claim 1, wherein the semi-spherical front surface comprises a compressible material.

3. The exercise training device of claim 1, wherein the at least one arm attaches the first bag portion and the second bag portion such that the rear surface is parallel to the second rear surface.

4. The exercise training device of claim 1, wherein the at least one arm attaches the first bag portion and the second bag portion such that the rear surface is co-planar with the second rear surface.

5. The exercise training device of claim 1, the at least one arm comprising a first arm attached to the rear surface.

6. The exercise training device of claim 5, wherein the handle extends substantially perpendicular to the first arm.

7. The exercise training device of claim 1, the attachment structure comprising a second handle configured to allow a user to hold the exercise training device, the second handle extending substantially parallel to the handle.

8. The exercise training device of claim 1, wherein the first bag portion is spaced a distance apart from the second bag portion.

9. The exercise training device of claim 8, wherein the distance is less than a cross-sectional size of the first bag portion.

10. An exercise training device comprising:
a first bag portion having a semi-spherical front surface and a rear surface;
a second bag portion having a semi-spherical second front surface and a second rear surface; and
an attachment structure comprising:
at least one arm extending between the first bag portion and the second bag portion, the at least one arm attached to the rear surface and the second rear surface such that the rear surface is parallel to the second rear surface and the first bag portion is spaced a distance apart from the second bag portion.

11. The exercise training device of claim 10, wherein the semi-spherical front surface comprises a compressible material.

12. The exercise training device of claim 10, wherein the at least one arm attaches the first bag portion and the second bag portion such that the rear surface is co-planar with the second rear surface.

13. The exercise training device of claim 10, wherein the first bag portion is spaced a distance apart from the second bag portion.

14. The exercise training device of claim 13, wherein the distance is less than a cross-sectional size of the first bag portion.

15. An exercise training device comprising:
a first bag portion having a semi-spherical front surface and a rear surface;
a second bag portion having a semi-spherical second front surface and a second rear surface;
a third bag portion having a semi-spherical third front surface and a third rear surface; and
an attachment structure comprising:
at least one arm extending between the first bag portion and the second bag portion, the at least one arm attached to the rear surface and the second rear surface;
at least one second arm extending between the second bag portion and the third bag portion, the at least one second arm attached to the second rear surface and the third rear surface; and
a handle attached to one or more of the at least one arm and the at least one second arm, the handle configured to allow a user to hold the exercise training device.

16. The exercise training device of claim 15, wherein the rear surface is substantially planar.

17. The exercise training device of claim 16, wherein the attachment structure extends substantially parallel to the rear surface.

18. The exercise training device of claim 15, comprising a connecting structure for attaching the rear surface of the first bag portion to the at least one arm.

19. The exercise training device of claim 18, the connecting structure defining a channel within which the at least one arm is received.

20. The exercise training device of claim 19, wherein the channel has a semi-circular shape.
